(19) United States
(12) Patent Application Publication
(10) Pub. No.: US 2024/0145948 A1
(43) Pub. Date: May 2, 2024

(54) EARTH GROUNDING ELECTRODE AND INSTALLATION THEREOF

(71) Applicant: A.C. Dandy Products Ltd., Wetaskiwin (CA)

(72) Inventor: Hans BROERE, Wetaskiwin (CA)

(21) Appl. No.: 18/165,109

(22) Filed: Feb. 6, 2023

(30) Foreign Application Priority Data
Oct. 28, 2022 (CA) 3180695

(51) Int. Cl. H01R 4/66

(52) U.S. Cl. CPC H01R 4/66; H01R 4/38

(57) ABSTRACT

An electrode for Earth grounding includes a plate for installation below a depth of covering material (e.g., soil or a foundation element), and a rod extending upwardly from a rod lower end attached to the plate, to a rod upper end for connection to a wire and disposed at a height above the plate that exceeds the depth of covering material. Accordingly, the connection to the wire is visible and accessible when the plate is installed below the depth of covering material. An installation is also provided including a concrete foundation element on a subgrade, a lower surface of the plate in contact with the grade, an upper surface of the plate and the rod lower end cast into the concrete foundation element, and the rod upper end disposed above the foundation element and exposed for connection to a wire.

### FIELD OF THE INVENTION

The present invention relates to Earth grounding electrodes.

### BACKGROUND OF THE INVENTION

Grounding plates and rods are electrodes that are buried in the ground, and connected by a wire, bus bar or the like to an electrical panel, lightening rod system, or other structure to conduct electricity to the Earth. Grounding plates typically need to be buried at depths of 2 to 3 feet, and may be used where subsoil conditions make it difficult to drive grounding rods to typically required depths of 8 to 10 feet. As shown in FIG. 6, a prior art grounding plate (100) has a short lug or stud (102) for connection to the wire. In use, the plate-to-wire connection is buried in the ground, and inaccessible for inspection and maintenance. Corrosion, age, subsidence, and other factors may compromise the connection, and result in a hazardous situation that prevents electricity from being conducted to the grounding plate and the Earth as intended.

### SUMMARY OF THE INVENTION

In one aspect, the present invention comprises a grounding electrode comprising a horizontal plate and a rod. The horizontal plate is for installation below a depth of covering material, such and soil or a foundation element. The rod extends upwardly from a rod lower end attached to the plate, to a rod upper end for connection to a wire or bar bus, and disposed at a height above the plate exceeding the depth of covering material. Accordingly, when the plate is installed below the depth of covering material, the rod upper end is disposed above the covering material, and the connection of the rod upper end to the wire remains visible for inspection, and accessible for maintenance.

In another aspect, the present invention comprises an installation on a subgrade. The installation comprises a concrete foundation element on the subgrade, and a grounding electrode. The grounding electrode comprises a horizontal plate comprising a plate lower surface in contact with the subgrade, and a plate upper surface cast into the concrete foundation element. The grounding electrode further comprises a rod extending upwardly from a rod lower end attached to the plate and cast into the concrete foundation element, to a rod upper end disposed above the foundation element and exposed for connection to a wire.

In another aspect, the present invention comprises a method of installing a grounding electrode on a subgrade. The method comprises the steps of: (a) placing the grounding electrode on the subgrade, the grounding electrode comprising: (i) a horizontal plate comprising a plate lower surface in contact with the subgrade, and a plate upper surface; and (ii) a rod extending upwardly from a rod lower end attached to the plate, to a rod upper end; and (b) pouring concrete to form a foundation element on the subgrade, wherein the plate upper surface and the rod lower end are cast into the foundation element, and wherein the rod upper end is disposed above the foundation element and exposed for connection to a wire.

In embodiments of the grounding electrode (as may be used in the installation and method described above), the rod may be attached to the plate by a weld. The plate may comprise a plate lower surface having an area of at least 1 square feet, and more particularly at least 2 square feet. The rod upper end may be disposed at a height of at least 24 inches above the plate. The rod may be attached to the plate at a position having a horizontal distance less than or equal to 2 inches from an edge of the plate.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The dimensions shown in the drawings are for illustration only and non-limiting of the present invention.

FIG. 1A shows an isometric view of an embodiment of a grounding electrode of the present invention.

FIG. 1B shows a side view of the embodiment of FIG. 1A, and

FIG. 2 shows a top view of the embodiment of FIG. 1A.

FIG. 3 shows an isometric view of an installation of the grounding electrode of FIG. 1A and concrete foundation elements on a subgrade.

FIG. 4 shows a side view of the embodiment of FIG. 3 and

FIG. 5 shows a top view of the embodiment of FIG. 3.

FIG. 6 is an isometric view of a grounding plate in the prior art.

### DETAILED DESCRIPTION OF THE INVENTION

### Definitions

The invention relates to a grounding electrode for Earth grounding. Any term or expression not expressly defined herein shall have its commonly accepted definition understood by a person skilled in the art.

Grounding Electrode.

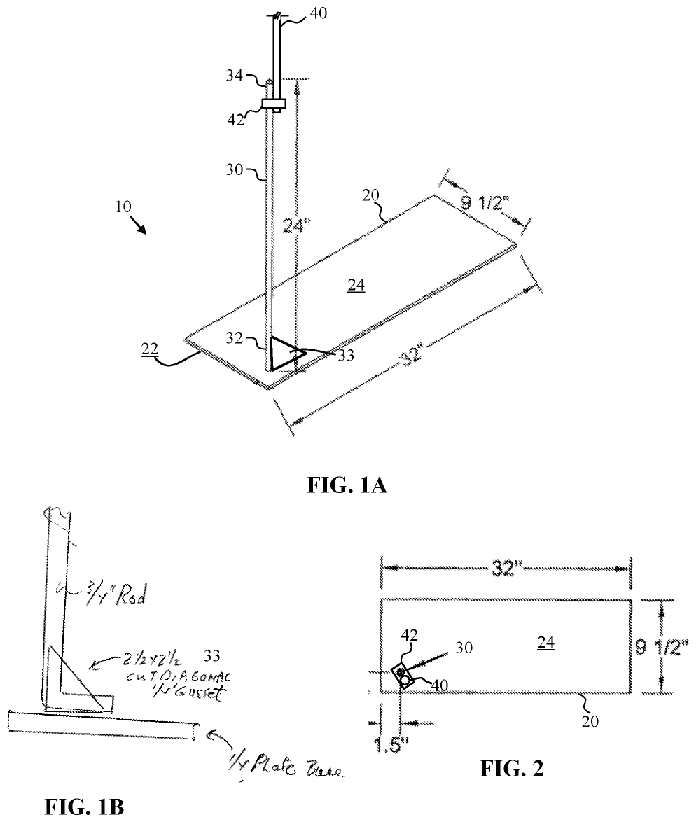

FIGS. 1A, 1B and 2 show an isometric view, side view, and top view, respectively, of an embodiment of a grounding electrode (10) of the present invention. The grounding electrode (10) may be made of a variety of electrically conductive materials, with ferrous metals (e.g., galvanized steel) and non-ferrous metals (e.g., copper) being non-limiting examples. The grounding electrode (10) includes a horizontal plate (20) and a rod. The rod (30) extends upwardly from a rod lower end (32) attached to the plate, to a rod upper end (34) for connection to a wire (40). The wire (40) may be connected to the rod upper end (34) using a suitable fastener (42) such as a clip or clamp. A non-limiting of a suitable fastener is an acorn clamp as is conventionally used to secure a wire to grounding rod. An acorn clamp comprises a member defining an aperture that receives the rod (30) and the wire (40), and a threaded aperture for a bolt to compress the rod (30) and the wire (40) together in the aperture.

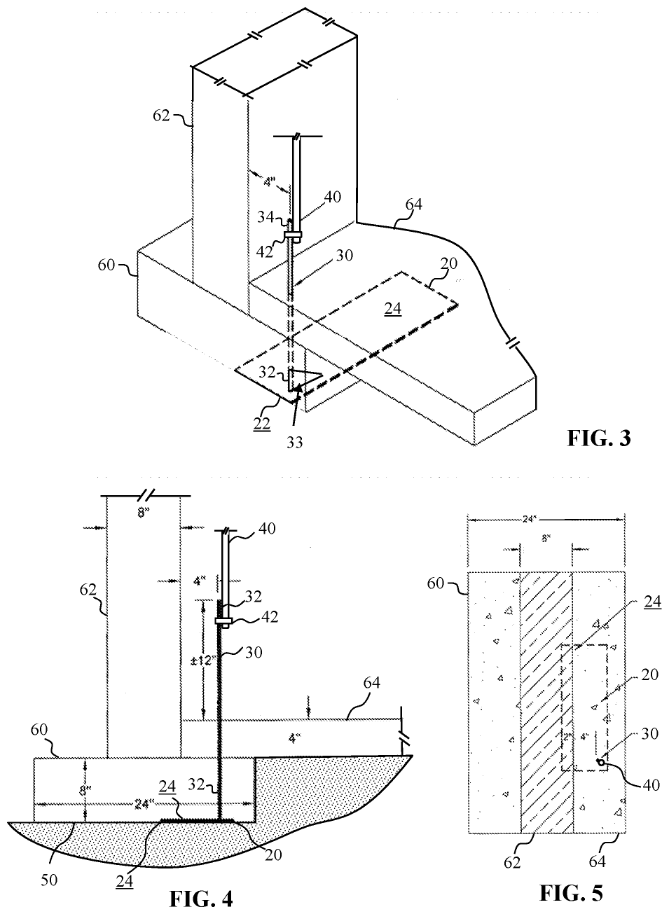

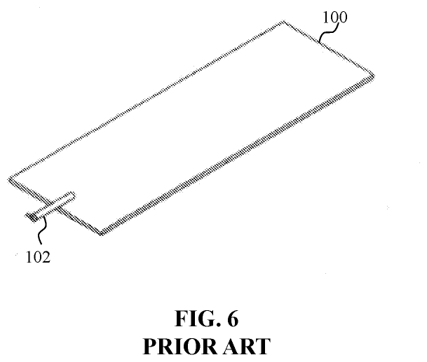

In use, the plate (20) is installed at a depth below a covering material, such as soil or a foundation element as described below in the example of FIGS. 3 to 5. The rod upper end (34) is at a height above the plate (20) that exceeds the depth over covering material. As a non-limiting example, if the plate (20) is to be installed at a depth of 24 inches (61 cm) below covering material, then the height of the rod upper end (34) above the plate (20) should be at least 24 inches (61 cm). In embodiments, the rod upper end (34) is disposed at a height of between 24 inches to 30 inches above the plate. Accordingly, when the plate (20) is installed at the depth below the covering material, the rod upper end (34) is disposed above the covering material and remains exposed for connection to a wire (40). The connection between the rod (30) and the wire (40) remains visible for inspection, and accessible for maintenance.

The plate (20) and rod (30) may have a variety of dimensions and shapes, and any dimensions shown or described are exemplary only. In the embodiment shown in FIGS. 1 and 2, the plate (20) has a vertical thickness of 0.25 inches (0.64 cm), and a rectangular footprint of about 32 inches×9.5 inches (81 cm×23 cm), such that each of the plate lower surface (22) and the plate upper surface (24) have an area of about 2.1 square feet (1961 square centimeters). In another embodiment, the plate (20) has a vertical thickness of 0.25 inches (0.64 cm), and a rectangular footprint of about 19 inches×8 inches (48 cm×20 cm), such that each of the plate lower surface (22) and the plate upper surface (24) have an area of about 1.1 square feet (981 square centimeters). In embodiments, each of the plate lower surface (22) and the plate upper surface (24) have an area of at least 1 square foot (929 square centimeters), and more particularly, at least 2 square feet (1858 square centimeters), and preferably about 4.0 to 4.5 square feet. The size of the plate may be selected having regard to requirements for minimum soil contact areas. In the embodiment shown in FIGS. 1 and 2, the rod (30) has a circular cross-section with a diameter of 0.625 inches (1.59 cm) and a length of 24 inches (61 cm). The length of the rod may be selected having regard to the depth of covering material overlying the plate (20), so that the rod upper end (34) and its connection to the wire (40) are disposed above the covering material.

The rod lower end (32) may be attached to the plate (20) by a variety of means, provided that the attachment means allows for electricity to flow from the rod (30) to the plate. In one embodiment, the rod lower end (32) and the plate (20) are attached by a weld. Preferably, a conductive angle gusset (33) provides physical strength and increased current flow capability to the connection between the plate and the rod.

In the embodiment shown in FIGS. 1 and 2, the rod lower end (32) is attached to the plate (20) at a position that is inset from the edges of the plate (20) meeting at a corner of the plate (20) by a horizontal distance of less than or equal to 2 inches, and more particularly about 1.5 inches. In other embodiments, the position of the attachment of the rod (30) to the plate (20) may be selected to accommodate considerations such as the position of overlaying foundation elements and nearby structures.

Installation of Grounding Electrode with Concrete Foundation Elements.

FIGS. 3, 4, and 5 show an isometric view, side view, and top view of an embodiment of an installation of the grounding electrode (10) of FIGS. 1 and 2, with concrete foundation elements of a residential building (e.g., a house). As an example, the ground is excavated to a depth to create a subgrade (50) (shown in FIG. 4) for the foundation. The subgrade (50) material may comprise soil or other ground materials having sufficient moisture content to act as an electrical grounding medium. Formwork (not shown) is positioned on the subgrade (50) for forming the foundation elements, including a footing (60) having a vertical depth of 8 inches (20 centimeters), a wall (62) having a thickness of 8 inches (20 centimeters) and a slab (64) having a vertical depth of 4 inches (10 centimeters). In this embodiment, the long edge of the plate (20) is parallel to the wall (62) to be constructed. The grounding electrode (10) is placed on the subgrade (50) such that the plate lower surface (22) is in contact with the subgrade (50). In this installation, the plate lower surface (22), but not the plate upper surface (24), is in contact with the subgrade (50), and therefore only the area of the plate lower surface (22) is considered for compliance with minimum soil contact area requirements for the plate (20). For example, a plate (20) having a rectangular footprint of about 32 inches×9.5 inches (81 cm×23 cm) may be used to comply with regulations requiring a minimum soil contact area of 2 square feet (1858 square centimeters). A horizontal clearance of 4 inches (10 centimeters) is provided between the foundation wall (62) and the rod (30) to facilitate subsequent removal of formwork. Concrete is poured into the formwork and onto the subgrade (50) and the plate (20) to form the footing (60), wall (62), and slab (64). When the concrete cures, the plate upper surface (24) and the rod lower end (32) are cast into the footing (60) and the slab (64). By virtue of the plate upper surface (24) and the rod lower end (32) being cast into the foundation elements, the concrete foundation elements may help to protect them from moisture and other environmental factors that could lead to their corrosion or damage. The rod upper end (34) is disposed above the slab (64) and remains exposed for connection to a wire (40) that leads to a structure to be grounded (e.g., an electrical panel).

Installation of Grounding Electrode by Direct Burial.

Alternatively, the grounding electrode (10) may be installed by direct burial in soil. As an example, the ground is excavated to a depth as may be required by regulations, which is typically at least 24 inches. The grounding electrode (10) is placed into the excavation with the plate lower surface (22) in direct contact with soil. The excavation is backfilled with soil such that the plate upper surface (24), while leaving the rod upper end (34) disposed above the backfill soil and exposed for connection to a wire (40). In this installation, the area of the both the plate lower surface (22) and plate upper surface (24) are in contact with soil, and may therefore be considered for compliance with minimum soil contact area requirements for the plate (20). For example, a plate (20) having a rectangular footprint of about 19 inches×8 inches (48 cm×20 cm) may be used to comply with regulations requiring a minimum soil contact area of 2 square feet (1858 square centimeters).

Interpretation.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A grounding electrode comprising:
(a) a horizontal plate for installation below a depth of covering material; and
(b) a rod extending upwardly from a rod lower end attached to the plate, to a rod upper end for connection to a wire and disposed at a height above the plate exceeding the depth of covering material, such that the rod upper end is disposed above the covering material when the plate is installed below the depth of covering material.

2. The grounding electrode of claim 1 wherein the rod is attached to the plate by a weld.

3. The grounding electrode of claim 1, further comprising a conductive gusset connecting the rod and the plate.

4. The grounding electrode of claim 1 wherein the plate comprises a plate lower surface having an area of at least 1 square feet for contact with a subgrade.

5. The grounding electrode of claim 1 wherein the height is at least 24 inches.

6. The grounding electrode of claim 1 wherein the rod is attached to the plate at a position having a horizontal distance less than or equal to 2 inches from an edge of the plate.

7. An installation on a subgrade comprising:
(a) a concrete foundation element on the subgrade; and
(b) a grounding electrode comprising:
(i) a horizontal plate comprising a plate lower surface in contact with the subgrade, and a plate upper surface cast into the concrete foundation element; and
(ii) a rod extending upwardly from a rod lower end attached to the plate and cast into the concrete foundation element, to a rod upper end disposed above the foundation element and exposed for connection to a wire.

8. The installation of claim 7 wherein the foundation element comprises a footing or a floor slab.

9. The installation of claim 7 wherein the rod is attached to the plate by a weld.

10. The installation of claim 7 wherein the grounding electrode further comprises a conductive gusset connecting the rod and the plate.

11. The installation of claim 7 wherein the plate lower surface has an area of at least 2 square feet.

12. The installation of claim 7 wherein the rod upper end is disposed at a height above the plate of at least 24 inches.

13. The installation of claim 7 wherein the rod is attached to the plate at a position having a horizontal distance less than or equal to 2 inches from an edge of the plate.

14. The installation of claim 7 further comprising the wire attached to the rod upper end.

15. A method of installing a grounding electrode on a subgrade, the method comprising the steps of:
(a) placing the grounding electrode on the subgrade, the grounding electrode comprising:
(i) a horizontal plate comprising a plate lower surface in contact with the subgrade, and a plate upper surface; and
(ii) a rod extending upwardly from a rod lower end attached to the plate, to a rod upper end; and
(b) pouring concrete to form a foundation element on the subgrade, wherein the plate upper surface and the rod lower end are cast into the foundation element, and wherein the rod upper end is disposed above the foundation element and exposed for connection to a wire.

16. The method of claim 15 wherein the foundation element comprises a footing or a floor slab.

17. The method of claim 15 wherein the rod is attached to the plate by a weld and/or a conductive gusset.

18. The method of claim 15 wherein the plate lower surface has an area of at least 2 square feet.

19. The method of claim 15 wherein the rod upper end is disposed at a height above the plate of at least 24 inches.

20. The method of claim 15 wherein the rod is attached to the plate at a position having a horizontal distance less than or equal to 2 inches from an edge of the plate.
